(19) United States
(12) Patent Application Publication
(10) Pub. No.: US 2017/0269585 A1
(43) Pub. Date: Sep. 21, 2017

(54) SYSTEM, METHOD AND SERVER FOR MANAGING STATIONS AND VEHICLES

(71) Applicant: SWARMX PTE. LTD., Singapore (SG)

(72) Inventors: Pulkit JAISWAL, Singapore (SG); Badrinarayanan RANGARAJAN, Singapore (SG)

(73) Assignee: SWARMX PTE. LTD., Singapore (SG)

(21) Appl. No.: 15/465,539

(22) Filed: Mar. 21, 2017

(30) Foreign Application Priority Data
Mar. 21, 2016 (SG) 10201602203Y

(51) Int. Cl. G05D 1/00; G01S 19/48; G05D 1/10; H04B 7/185; H04L 29/08

(52) U.S. Cl. CPC G05D 1/0016; H04B 7/18506; H04L 67/10; G05D 1/0027; G05D 1/0022; G05D 1/104; G01S 19/48

(57) ABSTRACT

The present invention relates to a system, method and server for managing stations and vehicles. The system, method and server are particularly relevant, but not limited that the server is operable to receive a signal from a user device, create a command based on the signal and allocate the command to a station, the station is operable to activate at least one vehicle based on the command and assign the command to the vehicle, and the vehicle is operable to receive the command from the station and generate data related to the command. Further, the system, method and station are particularly relevant, but not limited that the server is operable to integrate the data generated from the vehicle into a representation of an area that the vehicle has surveyed.

### RELATED APPLICATIONS

This application claims priority to the Singapore Patent Application No. 10201602203Y filed on Mar. 21, 2016, the content of which is incorporated by reference in its entirety herein.

### FIELD OF INVENTION

The present invention relates to a system, method and server for managing stations and vehicles. The system, method and server are particularly relevant, but not limited to manage the stations and vehicles via a real-time communication channel.

### BACKGROUND ART

The following discussion of the background to the invention is intended to facilitate an understanding of the present invention only. It should be appreciated that the discussion is not an acknowledgement or admission that any of the material referred to was published, known or part of the common general knowledge of the person skilled in the art in any jurisdiction as at the priority date of the invention.

The robotics technology has changed the world we live in. With the technological advances, unmanned aerial vehicles (UAVs), commonly known as drones, have mostly found military and special operation applications, but also are increasingly finding uses in civil applications, such as policing, surveillance and firefighting, and in enterprises, such as remote controlled toys and cameras.

Therefore, UAVs are an emerging technology that is being deployed in multiple role worldwide. However, despite the potential for the technology to revolutionize many standard processes, there is a limitation. This is mainly because UAV operations still require manual input from human operators, whether for maintenance or piloting for missions.

The UAVs generate huge amount of data, e.g. video data, during flight of the UAVs. The UAVs are unable to process the video data during flight of the UAVs. Therefore, The UAVs and operators return to headquarters just to process and upload the data. The process and upload of data may involve memory cards manually swapped by the human operators. Therefore, there exists a need for a solution to process and upload data collected from the UAVs without human's manual operation.

Further, as a plurality of UAVs and stations are used, there exists a need for a solution to link the UAVs and stations into a seamless collective that shares information and to control the UAVs and stations in a synchronized manner. Also, data collected by the UAVs and the stations need to be processed and made comprehensible to the user.

### SUMMARY OF THE INVENTION

Throughout the specification, unless the context requires otherwise, the word “comprise” or variations such as “comprises” or “comprising”, will be understood to imply the inclusion of a stated integer or group of integers but not the exclusion of any other integer or group of integers.

Furthermore, throughout the specification, unless the context requires otherwise, the word “include” or variations such as “includes” or “including”, will be understood to imply the inclusion of a stated integer or group of integers but not the exclusion of any other integer or group of integers.

The present invention seeks to integrate data collected by the vehicle into a coherent representation of an area that the vehicle has surveyed in order to provide to a user.

In accordance with first aspect of the present invention there is a system for managing stations and vehicles comprising: a server operable to receive a signal from a user device, create a command based on the signal, and allocate the command to a station; the station operable to activate at least one vehicle based on the command and assign the command to the vehicle; the vehicle operable to receive the command from the station and generate data related to the command; and wherein the server is operable to integrate the data generated from the vehicle into a representation of an area that the vehicle has surveyed.

Preferably, the station initially processes the data and sends the processed data to the server, and the server integrates the received data into the representation of the area.

Preferably, the server includes a cloud.

Preferably, the signal includes GPS coordinates, and the cloud validates the GPS coordinates and creates a route on a map in order to create the command.

Preferably, the cloud figures out how to deploy the vehicle in order to create the command.

Preferably, the cloud allocates the command to the station via a real-time communication channel.

Preferably, the cloud monitors external environment, recognizes a predetermined object in the external environment, and controls the vehicle to avoid the predetermined object.

Preferably, the station assigns the command to the vehicle via a real-time communication channel.

Preferably, the vehicle sends the data to at least one of the station and the cloud while the vehicle performs the command.

Preferably, the station receives data from the vehicle, compresses the data with a secured key, and sends the compressed data to the cloud.

Preferably, the cloud unlocks the compressed data and converts the unlocked data to a predetermined format.

Preferably, the data includes at least one of telemetry data, imagery data and sensor data.

Preferably, the vehicle tags the imagery data with at least one of location information and time information and sends the tagged imagery data to the station.

Preferably, the vehicle tags vulnerable imagery data with an alert.

Preferably, the station initially processes the imagery data in order to send the alert to the cloud in case the vulnerable imagery data is found.

Preferably, when the cloud receives the alert with the vulnerable imagery data from the station, the cloud analyses the vulnerable imagery data for reporting.

Preferably, the cloud receives the telemetry data from the station, and processes the telemetry data in order to collect information on overall path of the vehicle.

Preferably, the cloud collects the imagery data and maps the area that the vehicle has surveyed using image tagging and image stitching.

Preferably, the image tagging includes at least one of objection detection, face detection, full body detection, pedestrian detection, license plate detection and scene recognition.

Preferably, the image stitching includes collating the imagery data based on the GPS coordinates.

Preferably, the imagery data that is processed and sent back to the cloud is purged from the station.

Preferably, the vehicle includes an on-board computer, wherein the on-board computer controls the vehicle to fly back to at least one of the station and a predetermined spot when the vehicle is out of a predetermined range of the station.

Preferably, the vehicle includes an on-board computer, wherein the on-board computer controls the vehicle to land to at least one of a closest station among at least one station and a predetermined spot when the vehicle runs out of battery power.

In accordance with second aspect of the present invention there is a method for managing stations and vehicles comprising: creating, by a server, a command based on a signal, wherein the signal is received from a user device; allocating, by the server, the command to a station; activating, by the station, at least one vehicle based on the command; assigning, by the station, the command to the vehicle; receiving the command at the vehicle from the station; generating, by the vehicle, data related to the command; and integrating, by the server, the data generated from the vehicle into a representation of an area that the vehicle has surveyed.

Preferably, the station initially processes the data and sends the processed data to the server, and the server integrates the received data into the representation of the area.

Preferably, the server includes a cloud.

Preferably, the signal includes GPS coordinates, and the cloud validates the GPS coordinates and creates a route on a map in order to create the command.

Preferably, the cloud figures out how to deploy the vehicle in order to create the command.

Preferably, the cloud allocates the command to the station via a real-time communication channel.

Preferably, the cloud monitors external environment, recognizes a predetermined object in the external environment, and controls the vehicle to avoid the predetermined object.

Preferably, the station assigns the command to the vehicle via a real-time communication channel.

Preferably, the vehicle sends the data to at least one of the station and the cloud while the vehicle performs the command.

Preferably, the station receives data from the vehicle, compresses the data with a secured key, and sends the compressed data to the cloud.

Preferably, the cloud unlocks the compressed data and converts the unlocked data to a predetermined format.

Preferably, the data includes at least one of telemetry data, imagery data and sensor data.

Preferably, the vehicle tags the imagery data with at least one of location information and time information and sends the tagged imagery data to the station.

Preferably, the vehicle tags vulnerable imagery data with an alert.

Preferably, the station initially processes the imagery data in order to send the alert to the cloud in case the vulnerable imagery data is found.

Preferably, when the cloud receives the alert with the vulnerable imagery data from the station, the cloud analyses the vulnerable imagery data for reporting.

Preferably, the cloud receives the telemetry data from the station, and processes the telemetry data in order to collect information on overall path of the vehicle.

Preferably, the cloud collects the imagery data and maps the area that the vehicle has surveyed using image tagging and image stitching.

Preferably, the image tagging includes at least one of objection detection, face detection, full body detection, pedestrian detection, license plate detection and scene recognition.

Preferably, the image stitching includes collating the imagery data based on the GPS coordinates.

Preferably, the imagery data that is processed and sent back to the cloud is purged from the station.

Preferably, the vehicle includes an on-board computer, wherein the on-board computer controls the vehicle to fly back to at least one of the station and a predetermined spot when the vehicle is out of a predetermined range of the station.

Preferably, the vehicle includes an on-board computer, wherein the on-board computer controls the vehicle to land to at least one of a closest station among at least one station and a predetermined spot when the vehicle runs out of battery power.

In accordance with third aspect of the present invention there is a server for managing stations and vehicles comprising: a service management module operable to receive a signal from a user device, create a command based on the signal, and allocate the command to a station; a station operation module operable to control the station to activate at least one vehicle based on the command and assign the command to the vehicle; a vehicle operation module operable to control the vehicle to receive the command from the station and generate data related to the command; and wherein the service management module is operable to integrate the data generated from the vehicle into a representation of an area that the vehicle has surveyed.

Preferably, the station operation module controls the station to initially process the data and send the processed data to the server, and the service management module integrates the received data into the representation of the area.

Preferably, the server includes a cloud.

Preferably, the signal includes GPS coordinates, and the service management module validates the GPS coordinates and creates a route on a map in order to create the command.

Preferably, the service management module figures out how to deploy the vehicle in order to create the command.

Preferably, the service management module allocates the command to the station via a real-time communication channel.

Preferably, the service management module monitors external environment and recognizes a predetermined object in the external environment, and the vehicle operation module controls the vehicle to avoid the predetermined object.

Preferably, the station operation module controls the station to assign the command to the vehicle via a real-time communication channel.

Preferably, the vehicle operation module controls the vehicle to send the data to at least one of the station and the cloud while the vehicle performs the command.

Preferably, the station operation module controls the station to receive data from the vehicle, compress the data with a secured key, and send the compressed data to the cloud.

Preferably, the service management module unlocks the compressed data and converts the unlocked data to a predetermined format.

Preferably, the data includes at least one of telemetry data, imagery data and sensor data.

Preferably, the vehicle operation module controls the vehicle to tag the imagery data with at least one of location information and time information and send the tagged imagery data to the station.

Preferably, the vehicle operation module controls the vehicle to tag vulnerable imagery data with an alert.

Preferably, the station operation module controls the station to initially process the imagery data in order to send the alert to the cloud in case the vulnerable imagery data is found.

Preferably, when the cloud receives the alert with the vulnerable imagery data from the station, the service management module analyses the vulnerable imagery data for reporting.

Preferably, the cloud receives the telemetry data from the station, and the service management module processes the telemetry data in order to collect information on overall path of the vehicle.

Preferably, the service management module collects the imagery data and maps the area that the vehicle has surveyed using image tagging and image stitching.

Preferably, the image tagging includes at least one of objection detection, face detection, full body detection, pedestrian detection, license plate detection and scene recognition.

Preferably, the image stitching includes collating the imagery data based on the GPS coordinates.

Preferably, the imagery data that is processed and sent back to the cloud is purged from the station.

Preferably, the vehicle operation module controls the vehicle to fly back to at least one of the station and a predetermined spot when the vehicle is out of a predetermined range of the station.

Preferably, the vehicle operation module controls the vehicle to land to at least one of a closest station among at least one station and a predetermined spot when the vehicle runs out of battery power.

Other aspects of the invention will become apparent to those of ordinary skill in the art upon review of the following description of specific embodiments of the invention in conjunction with the accompanying figures or by combining the various aspects of invention as described above.

### BRIEF DESCRIPTION OF THE DRAWINGS

The present invention will now be described, by way of example only, with reference to the accompanying drawings, in which:

FIG. 1 illustrates a flow diagram of a server, station and vehicle in accordance with an embodiment of the invention.

FIG. 2 illustrates a block diagram of a server in accordance with an embodiment of the invention.

FIG. 3 illustrates a block diagram of a station in accordance with an embodiment of the invention.

FIG. 4 illustrates a block diagram of a vehicle in accordance with an embodiment of the invention.

FIG. 5 illustrates an example of a server, station and vehicle in accordance with an embodiment of the invention.

### DESCRIPTION OF EMBODIMENTS OF THE INVENTION

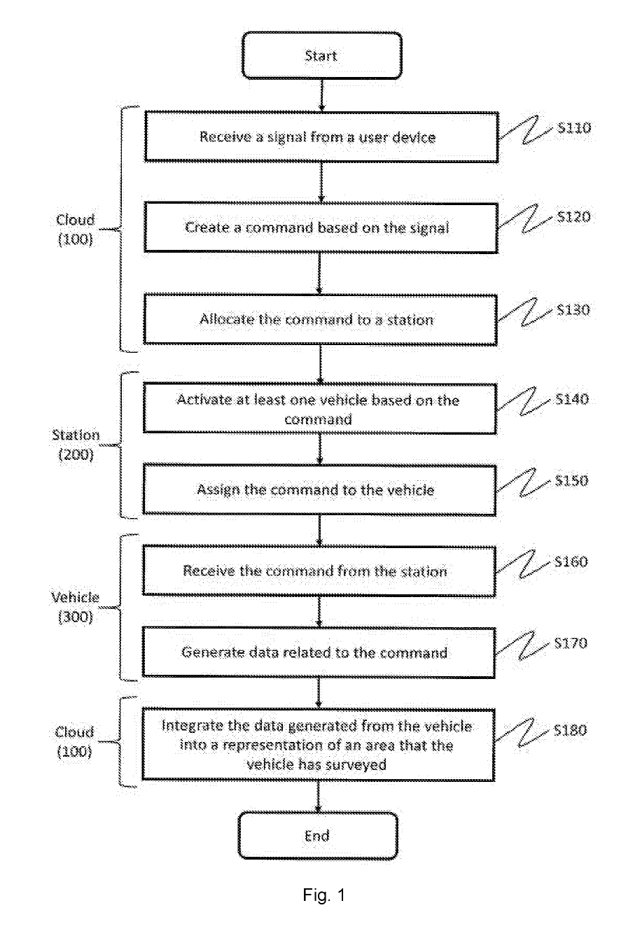

FIG. 1 illustrates a flow diagram of a server 100, station 200 and vehicle 300 in accordance with an embodiment of the invention.

The system includes one or more servers 100 (hereafter referred to the cloud), one or more stations 200 and one or more vehicles 300. The cloud 100 is a centralized server that acts as a communication channel between at least one station 200, at least one vehicle 300 and a user. The station 200 is for docking or parking at least one vehicle 300 therein.

The system may also include a plurality of stations and a plurality of vehicles. The system ties together the plurality of stations and the plurality of vehicles into an integrated system. The user is able to monitor and control the plurality of stations and the plurality of vehicles via a single interface provided by the cloud 100.

Data transmission between the station 200, the vehicle 300 and user devices, e.g. computer, server, mobile device, are managed by the operating system (OS). The cloud 100 is able to be set as a private cloud or a public cloud. In private settings, the OS and the user devices are hosted on a closed and secure intranet network. In public settings, the OS and the user devices are connected via the internet, e.g. 3G, 4G.

In accordance with an embodiment of the invention and as shown in the FIG. 1, firstly, the cloud 100 receives a signal from a user device (S110). The user uses the cloud 100 to initiate a following process and logs into the cloud 100 with a predetermined application program interface (API) key. Then, the cloud 100 provides at least one of suggestion information, status information of the station 200 and status information of the vehicle 300. The suggestion information may be provided based on previous commands.

The user chooses GPS coordinates using the user device. The user chooses the GPS coordinates on an execution screen of the cloud 100 and the cloud 100 receives the user's input, i.e. the signal including the selected GPS coordinates. Alternatively, the user may choose the GPS coordinates on an execution screen of any map application, and the user device may convert the selected GPS coordinates to the signal in order to transmit the signal to the cloud 100. After that, the user device transmits the signal to the cloud 100. The signal is transmitted to the cloud 100 in the form of at least one of electronic packet, short message service (SMS), multimedia message service (MMS), unstructured supplementary service data (USSD) and metadata.

The cloud 100 creates a command based on the signal (S120). The cloud 100 validates the GPS coordinates and creates a route on a physical map in order to create the command. Specifically, the signal inputted by the user device was simply defined, therefore, the cloud 100 figures out how exactly to deploy the at least one vehicle 300 to fulfil a mission.

The cloud 100 allocates the command to at least one station 200 (S130). This step includes at least one step below. The cloud 100 checks respective status information of the stations in order to determine whether the stations are able to assign the command to the vehicle 300. The cloud 100 selects at least one station based on at least one of the command and the status information of the stations. For example, if the command is related to a spot A, the cloud 100 selects a station 200 that is the nearest to the spot A. After that, the cloud 100 transmits the command to the selected station. This is established using a real-time communication channel through internet connectivity.

After that, the station 200 activates at least one vehicle 300 based on the command (S140) and assigns the command to the vehicle 300 (S150). This is established using a real-time communication channel through at least one of radio frequency and wireless internet data connectivity. The station 200 selects at least one vehicle 300 based on the command or status information of the vehicles, and activates the selected vehicle 300. For example, if the command is related to a spot A, the station 200 activates a vehicle 300 that is the nearest to the spot A. Alternatively, the station 200 selects a vehicle 300 having full battery power.

Although not shown, the cloud 100 may select at least one vehicle 300 based on the command or status information of the vehicles, and transmit the command including information of the selected vehicle 300 to the station 200. After that, the station 200 assigns the command to the selected vehicle 300 based on the information.

If the station 200 selects a plurality of vehicles (hereafter referred to the first vehicle 300a and second vehicle 300b), the station 200 is able to assign different commands to each of the first and second vehicle 300a, 300b. For example, the station 200 assigns a first command related to the upper side of the spot A to the first vehicle 300a and a second command related to the lower side of the spot A to the second vehicle 300b. Alternatively, the cloud 100 may also select the first and second vehicle 300a, 300b, and transmit the command including information of the selected vehicles 300a, 300b to the station 200 so that the station 200 could assign the command to the selected vehicles 300a, 300b.

The vehicle 300 receives the command from the station 200 using a real-time communication channel (S160). The vehicle 300 performs the mission based on the command. As a result, the vehicle 300 generates data related to the command (S170). The data includes at least one of telemetry data, imagery data and sensor data.

The telemetry data includes location information and position information of the vehicle 300. Specifically, the telemetry data includes at least one of GPS coordinates, heading (direction), battery life, flight time and motor temperature of the vehicle 300. The imagery data (also referred to the mission data) includes video data and photograph data captured from the camera mounted on the vehicle 300. The sensor data includes information with regard to the external environment, e.g. light, heat and weather. The telemetry data and the sensor data is light, e.g. few kilobytes. On the other hand, the mission data is heavy, e.g. gigabyte.

An on-board computer of the vehicle 300 tags the imagery data with at least one of location information and time information that the imagery data is captured and transmits the imagery data to the station 200 for further processing. The on-board computer of the vehicle 300 tags vulnerable imagery data with an alert. Likewise, every vehicle transmits information back to the station 200.

The vehicle 300 transmits the imagery data to at least one of the cloud 100 and the station 200 through at least one of radio frequency and wireless internet data connectivity while the vehicle 300 is performing the mission. Also, the vehicle 300 transmits the telemetry data or the sensor data back to the station 200 while the vehicle 300 is performing the mission related to the command.

Finally, the cloud 100 integrates the data generated from the vehicle 300 into a coherent representation of an area that the vehicle 300 has surveyed (S180).

The station 200 receives the data from the vehicle 300. The station 200 stores the data for a predetermined time. The station 200 compresses the data with a secured key and transmits the compressed data to the cloud 100. The cloud 100 will unlock the compressed data and convert the data to a predetermined format as an acceptable format.

The station 200 initially processes the imagery data in order to send the immediate alert to the cloud 100 when threats and vulnerabilities are found, e.g. human presence, objection detection, heat signatures depending on what kind of analysis that the user needs. The station 200 processes the imagery data using a tagging algorithm. Particularly, the station 200 tags the imagery data when person or a predetermined object is found. The station 200 then transmits the imagery data to the cloud 100 for further analysis.

The cloud 100 receives the imagery data from the station 200. The cloud 100 analyses the imagery data using various machine learning methods as follows. If the cloud 100 receives the vulnerable imagery data with the alert, the cloud 100 analyses the vulnerable imagery data for reporting to the user.

The cloud 100 collects all the imagery data captured by the vehicle 300 and maps the entire area that the vehicle 300 has surveyed using various machine learning methods, e.g. image tagging algorithm and image stitching algorithm. Alternatively, the cloud 100 collects all the imagery data collected by a plurality of vehicles, processes the data and makes a comprehensible data to the user using various machine learning methods, e.g. image tagging algorithm and image stitching algorithm.

Specifically, the image stitching algorithm includes collating the imagery data based on the GPS coordinates. The GPS coordinates are location information where the imagery data was captured. Firstly, the cloud 100 selects one or more imagery data among all the imagery data based on the analysis. For example, the cloud 100 removes irrelevant imagery data to the mission. The cloud 100 combines the selected imagery data with overlapping at least a part of the imagery data to produce a segmented panorama or high-resolution imagery data. The cloud 100 conducts the overlapping between the imagery data based on the GPS coordinates in order to map the area that the vehicle 300 has surveyed.

Further, the image tagging algorithm includes at least one of object detection, face detection, full body detection, pedestrian detection, license plate detection and scene recognition using various emotional cues. For example, the cloud 100 stores object images that are classified into a plurality of classes, e.g. human, stone, woods, on the database. When the cloud 100 collects all the imagery data, the cloud 100 recognizes objects within the imagery data and classifies the objects referring to the database. Thereafter, the cloud 100 tags the objects with information. If the cloud 100 does not store object A on the database, the user or another server is able to define the object with the appropriate object information, e.g. tree. The cloud 100 stores the object A with the object information on the database. After that, the cloud 100 is able to recognize the object A or a similar object as a tree.

According to the method described above, the cloud 100 integrates the imagery data into a coherent representation including information of objects. Consequently, the cloud 100 is able to provide the user with a far broader view and useful information of the operational area.

In addition, the imagery data that is processed and sent back to the cloud 100 is purged from the station 200.

The cloud 100 also receives the telemetry data from the station 200. The telemetry data is queued back to the cloud 100 for further processing, e.g. tracking of the vehicle 300. Further, the status information of the vehicle 300 (also referred to the vehicle heartbeat) is sent back to the cloud 100. The status information of the vehicle 300 means the overall health of the vehicle 300 and includes at least one of communication strength, battery level, storage level and sensor health. The cloud 100 processes the telemetry data in order to collect information on overall path of the vehicle 300 across dates and times. In this way, the cloud 100 is able to learn and report about the path taken by the vehicle 300 and provide the path to the user.

Although not shown, data processing may be omitted if the user or the mission requires a live image feed from the vehicle 300 without processing.

The above steps happen in a synchronized manner until the vehicle 300 is back to the station 200 for charging or when the mission is completed.

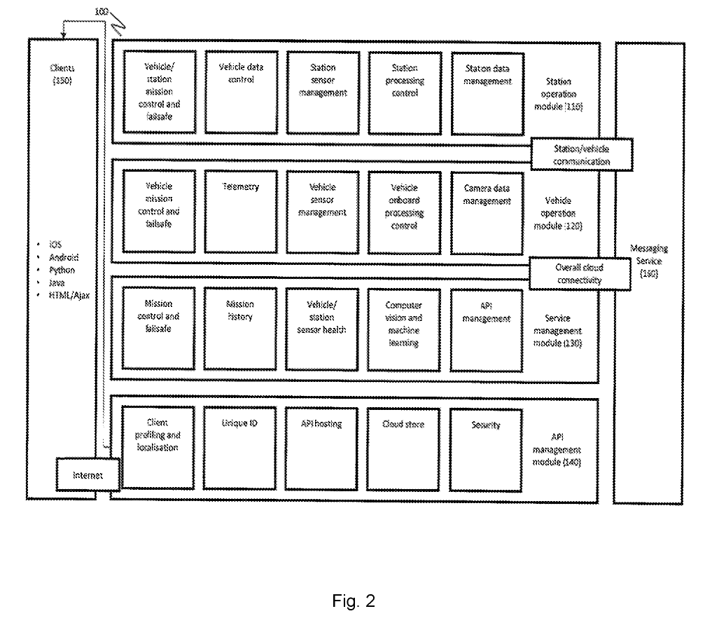

FIG. 2 illustrates a block diagram of a server in accordance with an embodiment of the invention. FIG. 2 depicts an overall architecture of the server 100 (hereafter referred to the cloud).

In accordance with an embodiment of the invention and as shown in the FIG. 2, the cloud 100 is a centralized system that acts as a communication channel between at least one station 200, at least one vehicle 300 and a user. The cloud 100 uses a hybrid messaging service, e.g. publish-subscribe and push-pull. The cloud 100 includes layers, and the layers include at least one of a station operation module 110, vehicle operation module 120, service management module 130 and application program interface (API) management module 140.

The station operation module 110 controls signals or information that provided to the station 200. Further, the station operation module 110 controls the station 200. For example, the station operation module 110 is operable to control the station 200 to activate at least one vehicle 300 based on the received command and assign the command to the vehicle 300. Accordingly, the station 200 receives the command as the mission from the cloud 100 and transmits the command to the vehicle 300.

The station operation module 110 controls sensors mounted on the station 200. The sensors mounted on the station 200 are at least one of an anemometer sensor, a GPS sensor, an IR beacon sensor, a gas sensor, a camera and RF tracker.

The station operation module 110 keeps a track of all the sensor data and the imagery data captured by the vehicle 300. The station 200 receives at least one of the telemetry data, imagery data and sensor data from the vehicle 300. The imagery data is stored on the station 200 for a predetermined time. The station operation module 110 controls the station 200 to initially process the imagery data for computer vision based on filtering of the data and send the imagery data to the cloud 100 for further processing. The imagery data that is processed and sent back to the cloud 100 is purged from the station 200.

The telemetry data is queued back to the station operation module 110 for further processing, e.g. the tracking of the vehicle 300. Further, the status information of the vehicle 300 (also referred to the vehicle heartbeat) is sent back to the station operation module 110.

The vehicle operation module 120 controls the vehicle 300. For example, the vehicle operation module 120 is operable to control the vehicle 300 to receive the command from the station 200 and generate data related to the command. Accordingly, the vehicle 300 receives the command as the mission from at least one of the cloud 100 and the station 200, and performs the mission related to the command.

The vehicle 300 includes at least one of an on-board computer and a flight computer. The on-board computer is attached on the vehicle 300 along with various sensors, e.g. GPS receiver, Wi-Fi inbound, radio frequency receiver, GSM SIM card along with camera modules. The on-board computer is used to capture the imagery data such as video data and send/stream the imagery data across internet to at least one of the cloud 100 and the station 200. In addition, the on-board computer acts as a location tracking device during a fail-safe time period. The on-board computer also sends an SOS signal back to at least one of the cloud 100 and the user device using at least one of SMS, email and massage feedback API.

The flight computer is attached on the vehicle 300 and takes commands to drive the vehicle 300.

At least one of the on-board computer and the flight computer keeps a track of the sensor data and status information of the sensors of the vehicle 300 (also referred to the sensor's health). The sensor data and the status information are sent back to the cloud 100 and station 200 through the communication protocol, e.g. GSM, 3G, 4G, 2.4 GHz bands.

The service management module 130 controls the commands and the data. The service management module 130 is operable to receive a signal from the user device, create the command based on the signal, and allocate the command to the station 200. In addition, the service management module 130 is operable to integrate the data generated from the vehicle 300 into a representation of an area that the vehicle 300 has surveyed.

Specifically, the service management module 130 sends the command to at least one of the station 200 and the vehicle 300. The service management module 130 keeps a track of commands for further analysis. The service management module 130 also keeps a track of the overall status information of the station 200 and the status information of the vehicle 300 with regard to date and time. The status information of the vehicle 300 includes at least one of a communication strength information, battery level information, storage level information and status information of the sensor.

The service management module 130 processes the imagery data received from the station 200. If the service management module 130 receives the vulnerable imagery data with the alert, the service management module 130 analyses the vulnerable imagery data for reporting to the user.

The imagery data is stitched together on the service management module 130 and analysed for useful information in order to report to the user. The service management module 130 collects all the imagery data and maps the entire area that the vehicle 300 has surveyed using various machine learning methods, e.g. image tagging algorithm and image stitching algorithm.

The image tagging algorithm includes at least one of objection detection, face detection, full body detection, pedestrian detection, license plate detection and scene recognition using various emotional cues. The image stitching algorithm includes collating the imagery data based on the GPS coordinates.

In addition, the service management module 130 monitors external environment and recognizes a predetermined object in the external environment. The service management module 130 controls the vehicle 300 so that the vehicle 300 could avoid the predetermined object. Specifically, the service management module 130 uses various machine learning algorithm for prediction and analysis of the data. The various learning algorithm includes at least one of obstacle avoidance models, image processing models, image stitching and object classification. The service management module 130 analyses the path and advises the station 200 and the vehicle 300. Accordingly, the vehicle 300 is able to recognize the suspicious object (also referred to the obstacle) and avoid the suspicious object. The vehicle 300 is able to deviate from a set path for monitoring the suspicious object.

The cloud API is built on the service management module 130 using representational state transfer (REST) architectural interfacing all the other models. The REST is an architectural style consisting of a coordinated set of architectural constraints applied to components, connectors, and data elements, within a distributed hypermedia system.

The client 150 is provided with a unique ID with regard to the respective features requested. The examples of the client 150 are iOS, Android, Python, Java and HTML-Ajax. The API management module 140 is hosted in a private cloud for the client 150.

The messaging service module 160 establishes a communication between the cloud 100, the station 200 and the vehicle 300. The messaging service module 160 uses a hybrid communication model, e.g. publish-subscribe and push-pull design pattern, to establish the overall communication. The cloud 100 receives the data and then passes the data to the client 150 when pinged. Although not shown, the cloud 100 does not receive the data and the data is only made available when the client 150 provides a direct request for the data. This could be implemented when more security is required.

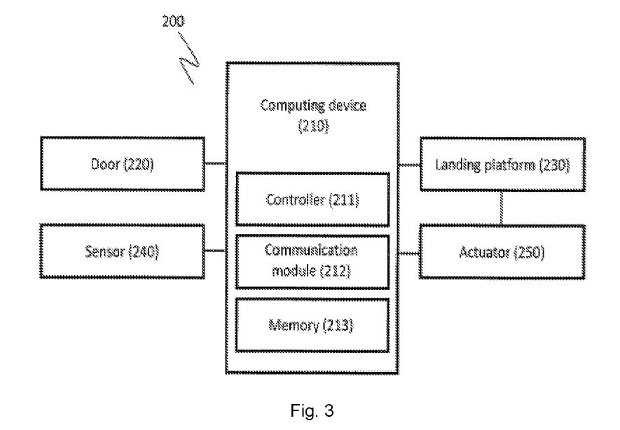

FIG. 3 illustrates a block diagram of a station in accordance with an embodiment of the invention.

The station 200 is for docking at least one vehicle 300 therein. The station 200 includes a computing device 210. The computing device 210 includes at least one of a controller 211, a communication module 212 and a memory 213.

The controller 211 is operable to control overall operations of the computing device 210 of the station 200. For example, the controller 211 processes data received from the vehicle 300. Specifically, the controller 211 initially processes the imagery data in order to send an alert to the cloud 100 when the vulnerable imagery data is found.

The communication module 212 is operable to data communicate with cloud 100 and vehicle 300 constantly and transmits/receives the data to/from the cloud 100 and vehicle 300 via at least one of wired and wireless communication. The example of the wireless communication includes radio frequency communication and wireless internet data connectivity. Particularly, the communication module 212 receives the command as the mission from the cloud 100, activates specific vehicle 300 based on the command, and assigns the command to the vehicle 300. Also, the communication module 212 receives at least one of the telemetry data, the imagery data and the sensor data from the vehicle 300 and transmits at least one of the telemetry data, the imagery data and the sensor data to the cloud 100. Alternatively, the communication module 212 transmits processed data to the cloud 100. In addition, the communication module 212 transmits/receives data to/from at least one network entities, e.g. base station, external device and server.

The communication module 212 supports internet access for the computing device 210 of the station 200. The communication module 212 may be internally or externally coupled to the computing device 210. The wireless Internet technology may include at least one of WLAN (Wireless LAN) (Wi-Fi), Wibro (Wireless broadband), Wimax (World Interoperability for Microwave Access), and HSDPA (High Speed Downlink Packet Access).

The memory 213 is used to store various types of data to support controlling and processing of the computing device 210. The data received from the vehicle 300 is stored on the memory 213. The memory 213 may be implemented using any type or combination of suitable volatile and non-volatile memory or storage devices including at least one of hard disk, random access memory (RAM), static random access memory (SRAM), electrically erasable programmable read-only memory (EEPROM), erasable programmable read-only memory (EPROM), programmable read-only memory (PROM), read-only memory (ROM), magnetic memory, flash memory, magnetic or optical disk, multimedia card micro type memory and card-type memory, e.g. SD memory or XD memory. The computing device 210 is able to operate in association with a web storage for performing a storage function of the memory 213 on internet.

The door 220 (also referred to the shutter) is installed upper side of the station 200 and controlled by the computing device 210. When the computing device 210 receives a landing mode signal or a docking signal from the vehicle 300, the computing device 210 controls the door 220 to be opened so that the vehicle 200 could land on the landing platform 230 inside the station 200. Although not shown, the station 200 further includes ultra-wide band sensors or laser pointer that are used for precision landing of the vehicle 300 on the landing platform 230.

The sensor 240 is installed outside the station 200 and detects the external environments, e.g. weather. The sensor 240 includes a hydro-sensor. The computing device 210 determines whether to open the door 220 based on the detected external environment. For example, if it is detected to be raining, the computing device 210 controls the door 220 to be closed. The sensor 240 is able to be varied according to the user's requirements and also be omitted if not required.

In addition, the station 200 includes at least one actuator 250 that corrects the vehicle's 300 final position on the landing platform 230. The actuator 250 is mechanical actuator and also functions as conductive charging points. The actuator 250 may be located on the landing platform 230, outside the landing platform 230, or be included in the landing platform 230. The computing device 210 controls the actuator 250 to start to charge the battery of the vehicle 300 when the door 220 of the station 200 is closed.

The vehicle 300 continually transmits at least one of the telemetry data, the imagery data and the sensor data of the vehicle 300 to the computing device 210 even while encase in the station 200.

In addition, the computing device 210 receives at least one of the telemetry data, the imagery data and the sensor data from the vehicle 300 during charging the battery of the vehicle 300. Meanwhile, the computing device 210 may receive at least one of the telemetry data, the imagery data and the sensor data in real time during both flight and charging. The computing device 210 compresses the data with a secured key and transmits the compressed data to the cloud 100. After that, the cloud 100 unlocks the compressed data and converts the data to a predetermined format, e.g. small format.

Traditionally, the data is collected only after the mission is completed on the vehicle 300 and then processed into usable information. The present invention is able to reduce the lag time between data acquisition and the information being presented to the user.

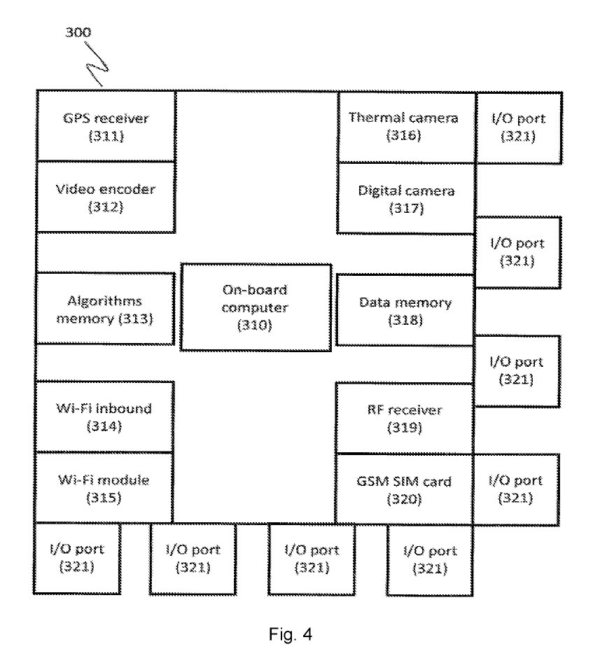

FIG. 4 illustrates a block diagram of a vehicle in accordance with an embodiment of the invention.

The vehicle 300 is not limited to unmanned aerial vehicles (UAVs), but may also be applicable to other autonomous devices that operate on the ground, such as unmanned ground vehicles (UGVs), or on the water, such as unmanned underwater vehicles (UUVs).

The vehicle 300 includes at least one of an on-board computer 310, GPS receiver 311, video encoder 312, algorithms memory 313, Wi-Fi inbound 314, Wi-Fi module 315, thermal camera 316, digital camera 317, data memory 318, radio frequency (RF) receiver 319, global system for mobile communication (GSM) subscriber identity module (SIM) card 320 and input/output (I/O) port 321.

The on-board computer 310 is operable to control overall operations of the vehicle 300. Although not shown, the vehicle 300 further includes a driving module that generates driving power and allows the vehicle 300 to take off and move in every direction. A telemetry sensor provides navigational data for the vehicle 300 to fly properly, i.e. fly a predetermined path. The telemetry sensor includes a compass.

The on-board computer 310 is attached on the vehicle 300 along with the communication sensors, e.g. GPS receiver 311, Wi-Fi inbound 314, Wi-Fi module 315, RF receiver 319, GSM SIM card 320 along with camera modules, e.g. thermal camera 316, digital camera 317. The on-board computer 310 transmits and receives data via the I/O port 321.

The sensors depend on the user requirement and the mission requirement. The vehicle 300 may carry infrared device or spectrography device instead of the camera modules. The camera modules may be omitted if the user or the mission do not require the camera modules. Although not shown, the vehicle 300 further includes at least one of an electro-optical sensor, a multispectral scanner, an ultra-wide band sensor and a 360 degrees camera.

The on-board computer 310 generates data including the telemetry data, the imagery data and the sensor data. The camera modules, e.g. digital camera 371, captures and generates the imagery data related to the command. The data memory 318 is used to store the data. The data memory 318 may be implemented using any type or combination of suitable volatile and non-volatile memory or storage devices. The vehicle 300 is able to operate in association with a web storage for performing a storage function of the data memory 318 on internet.

The on-board computer 310 is operable to data communicate with the station 200 constantly and transmits/receives data to/from the station 200. In addition, the on-board computer 310 transmits/receives data to/from the cloud 100 and at least one network entities, e.g. base station, external device and server.

The on-board computer 310 is used to send the imagery data across internet to at least one of the cloud 100 and the station 200. The on-board computer 310 streams the imagery data across internet to at least one of the cloud 100 and the station 200 using a video encoder 312. The on-board computer 310 is small-scale powerful computer.

The on-board computer 310 may transmit the imagery data to at least one of the cloud 100 and the station 200 during charge of the vehicle 300 via at least one of wired and wireless communication. Meanwhile, the on-board computer 310 may transmit the imagery data to at least one of the cloud 100 and the station 200 during flight of the vehicle 300 via wireless communication.

The on-board computer 310 tags the imagery data with at least one of location information and time information that the imagery data is captured and transmits the tagged imagery data to the station 200 for further processing. If a vulnerable imagery data is found, the on-board computer 310 tags the vulnerable imagery data with an alert. Likewise, every vehicles 300 send information back to the station 200. After that, the station 200 initially processes the imagery data in order to send the alert to the cloud 100 in case the vulnerable imagery data is found.

In addition, the on-board computer 310 acts as a location tracking device during a fail-safe time period. Because, the cloud 100 hosts the fail-safe mechanism which starts to act immediately when the station 200 or the vehicle 300 are out of range or incommunicable. The on-board computer 310 also sends an SOS signal back to at least one of the cloud 100 and the user device using at least one of SMS, email and massage feedback API.

With regard to the fail-safe mechanism, the on-board computer 310 controls the vehicle 300 to fly back to at least one of the station 200 and a predetermined spot when the vehicle 300 is out of a predetermined range of the station 200. Specifically, the vehicle 300 is able to communicate with the internet even when the vehicle 300 is out of range of the station 200. Whenever the vehicle 300 is out of range or incommunicable, the algorithm stored on the algorithm memory 313 or on the on-board computer 310 triggers the vehicle 300 to fly back to the station 200 or to the predetermined spot.

The on-board computer 310 controls the vehicle 300 to land to at least one of a closest station among at least one station and a predetermined spot when the vehicle 300 runs out of battery power. Specifically, whenever the vehicle 300 runs out of battery power, the algorithm stored on the algorithm memory 313 or on the on-board computer 310 advises the vehicle 300 to land on at least one of the closest station and the predetermined spot.

Accordingly, the present invention is able to control the vehicle 300 on the basis of internet protocol (IP) and non-IP.

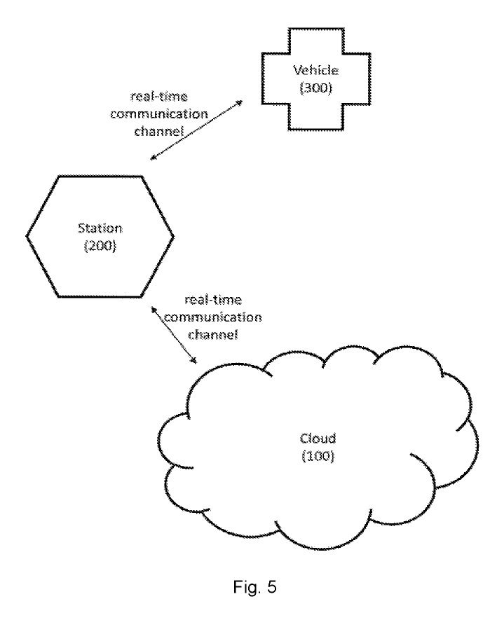

FIG. 5 illustrates an example of a server, station and vehicle in accordance with an embodiment of the invention.

Referring to the FIG. 5, the system includes the cloud 100, the station 200 and the vehicle 300. The station 200 is a place to host the vehicle 300. The station 200 processes intermediary data analysis and physically charge the vehicle 300. The bi-directional connectivity in the system is established by at least one of Wi-Fi, radio frequency and wireless internet data connection. Alternatively, the bi-directional connectivity is established by pulsed laser communication or satellite based transmissions.

The system ties together a plurality of stations and a plurality of vehicles into an integrated system. The plurality of stations share information including at least one of availability of the vehicles, location of the vehicles, charging strength and external environment information, e.g. light, heat and weather. The plurality of stations and the plurality of vehicles share at least one of the imagery data and the telemetry data, e.g. location, position and battery level information.

The user is able to monitor and control the plurality of stations and the plurality of vehicles via a single interface by accessing the cloud 100. The cloud 100 transmits electronic messages including the command (also referred to the mission profile) to the station 200 via real-time communication channel. Then, the cloud 100 transmits electronic messages including the command to the vehicle 300 via real-time communication channel. The electronic messages may be stored in the database of the cloud 100 and kept for fail-safe operations.

The station 200 receives electronic messages including at least one of the telemetry data of the vehicle 300, imagery data of the vehicle 300, sensor data of the vehicle 300 and battery level of the vehicle 300 from the vehicle 300 via real-time communication channel. The cloud 100 also receives electronic messages including at least one of the telemetry data of the vehicle 300, imagery data of the vehicle 300, sensor data of the vehicle 300, sensor data of the station 200, battery level of the vehicle 300 and charging capacity level of the station 200 from the station 200 via real-time communication channel. The electronic messages are stored in the database of the cloud 100 and kept for fail-safe operations.

Although not shown, the cloud 100 may reside on the station 200 and transmit/receive the data to/from the vehicle 300. Also, although not shown, the system may be an encompassing network of various sensors and client facing devices. For example, the system may include vehicles, stations, security cameras and motion detectors. The user device may be a form of a vehicle mounted computer systems and mobile devices.

It should be appreciated by the person skilled in the art that variations and combinations of features described above, not being alternatives or substitutes, may be combined to form yet further embodiments falling within the intended scope of the invention.

1. A system for managing stations and vehicles comprising:
a server operable to receive a signal from a user device, create a command based on the signal, and allocate the command to a station;
the station operable to activate at least one vehicle based on the command and assign the command to the vehicle;
the vehicle operable to receive the command from the station and generate data related to the command; and
wherein the server is operable to integrate the data generated from the vehicle into a representation of an area that the vehicle has surveyed.

2. The system for managing stations and vehicles according to claim 1, wherein the station initially processes the data and sends the processed data to the server, and the server integrates the received data into the representation of the area.

3. The system for managing stations and vehicles according to claim 2, wherein the server includes a cloud.

4. The system for managing stations and vehicles according to claim 3, wherein the signal includes GPS coordinates, and the cloud validates the GPS coordinates and creates a route on a map in order to create the command.

5. The system for managing stations and vehicles according to claim 4, wherein the cloud figures out how to deploy the vehicle in order to create the command.

6. The system for managing stations and vehicles according to claim 5, wherein the cloud allocates the command to the station via a real-time communication channel.

7. The system for managing stations and vehicles according to claim 3, wherein the cloud monitors external environment, recognizes a predetermined object in the external environment, and controls the vehicle to avoid the predetermined object.

8-23. (canceled)

24. A method for managing stations and vehicles comprising:
creating, by a server, a command based on a signal, wherein the signal is received from a user device;
allocating, by the server, the command to a station;
activating, by the station, at least one vehicle based on the command;
assigning, by the station, the command to the vehicle;
receiving the command at the vehicle from the station;
generating, by the vehicle, data related to the command; and
integrating, by the server, the data generated from the vehicle into a representation of an area that the vehicle has surveyed.

25. The method for managing stations and vehicles according to claim 24, wherein the station initially processes the data and sends the processed data to the server, and the server integrates the received data into the representation of the area.

26. The method for managing stations and vehicles according to claim 25, wherein the server includes a cloud.

27. The method for managing stations and vehicles according to claim 26, wherein the signal includes GPS coordinates, and the cloud validates the GPS coordinates and creates a route on a map in order to create the command.

28. The method for managing stations and vehicles according to claim 27, wherein the cloud figures out how to deploy the vehicle in order to create the command.

29. The method for managing stations and vehicles according to claim 28, wherein the cloud allocates the command to the station via a real-time communication channel.

30. The method for managing stations and vehicles according to claim 26, wherein the cloud monitors external environment, recognizes a predetermined object in the external environment, and controls the vehicle to avoid the predetermined object.

31-46. (canceled)

47. A server for managing stations and vehicles comprising:
a service management module operable to receive a signal from a user device, create a command based on the signal, and allocate the command to a station;
a station operation module operable to control the station to activate at least one vehicle based on the command and assign the command to the vehicle;
a vehicle operation module operable to control the vehicle to receive the command from the station and generate data related to the command; and
wherein the service management module is operable to integrate the data generated from the vehicle into a representation of an area that the vehicle has surveyed.

48. The server for managing stations and vehicles according to claim 47, wherein the station operation module controls the station to initially process the data and send the processed data to the server, and the service management module integrates the received data into the representation of the area.

49. The server for managing stations and vehicles according to claim 48, wherein the server includes a cloud.

50. The server for managing stations and vehicles according to claim 49, wherein the signal includes GPS coordinates, and the service management module validates the GPS coordinates and creates a route on a map in order to create the command.

51. The server for managing stations and vehicles according to claim 50, wherein the service management module figures out how to deploy the vehicle in order to create the command.

52. The server for managing stations and vehicles according to claim 51, wherein the service management module allocates the command to the station via a real-time communication channel.

53-69. (canceled)
